(19) United States
(12) Patent Application Publication
(10) Pub. No.: US 2022/0375636 A1
(43) Pub. Date: Nov. 24, 2022

(54) Multipurpose small modular fluoride-salt-cooled high-temperature reactor energy system

(71) Applicant: XI'AN JIAOTONG UNIVERSITY, Xi'an (CN)

(72) Inventors: Dalin Zhang, Xi'an (CN); Dianqiang Jiang, Xi'an (CN); Xinyu Li, Xi'an (CN); Xin Min, Xi'an (CN); Chenglong Wang, Xi'an (CN); Wenxi Tian, Xi'an (CN); Suizheng Qiu, Xi'an (CN); Guanghui Su, Xi'an (CN)

(21) Appl. No.: 17/880,319

(22) Filed: Aug. 3, 2022

(30) Foreign Application Priority Data
Aug. 30, 2021 (CN) 202111007626.1

(51) Int. Cl. G21C 15/28; G21C 5/02; G21C 15/12; G21C 15/18; F01K 7/32

(52) U.S. Cl. CPC G21C 15/28; G21C 5/02; G21C 15/12; G21C 15/18; F01K 7/32

(57) ABSTRACT

A multipurpose small modular fluoride-salt-cooled high-temperature reactor energy system includes: a reactor body system, a passive residual heat removal system, a compact supercritical carbon dioxide Brayton cycle system, a secondary loop system, and a comprehensive utilization supercritical carbon dioxide Brayton cycle system. Nuclear reactor adopts helical cruciform fuel and graphite matrix material filled with TRISO element, which can improve heat transfer performance and inherent safety. Thermal efficiency of the compact supercritical carbon dioxide Brayton cycle system is above 48%, which can be used in places with limited space. Thermal efficiency of the comprehensive utilization supercritical carbon dioxide Brayton cycle system is above 54%, which can be applied to places with abundant resources. The present invention not only realizes efficient and compact utilization of energy, but also meets the needs of multiple purposes, integrated production, storage and conversion of energy.

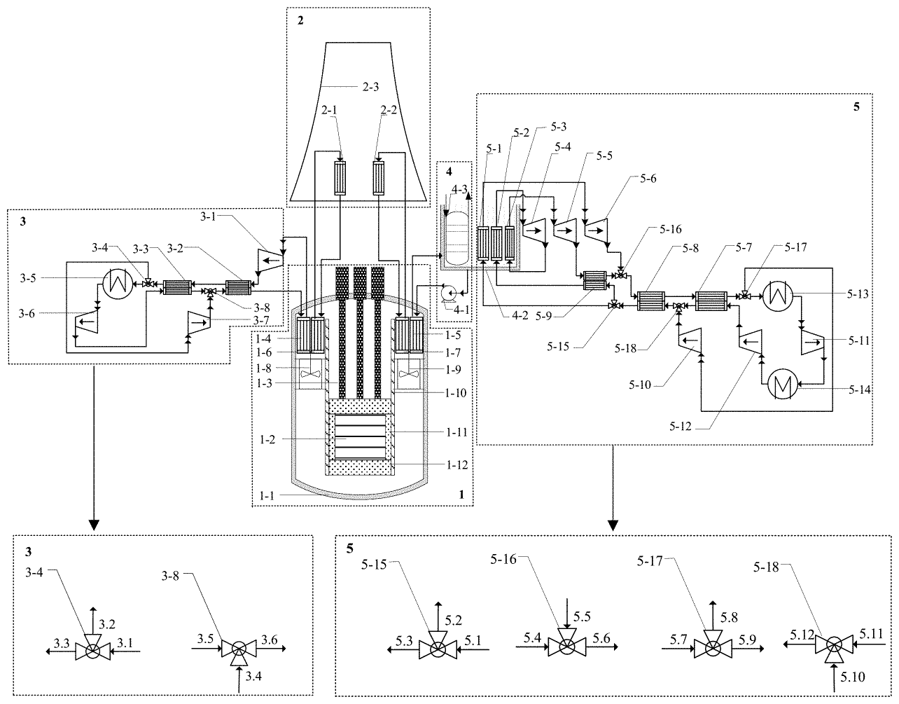

### CROSS REFERENCE OF RELATED APPLICATION

The present invention claims priority under 35 U.S.C. 119(a-d) to CN 202111007626.1, filed Aug. 30, 2021.

### BACKGROUND OF THE PRESENT INVENTION

### Field of Invention

The present invention relates to a technical field of advanced nuclear energy development and comprehensive utilization of energy, and more particularly to a multipurpose small modular fluoride-salt-cooled high-temperature reactor energy system.

### Description of Related Arts

Energy supports the survival and development of modern human beings, and the large-scale utilization of fossil energy has promoted the progress of society. However, the reserves of fossil energy are limited while the use of fossil energy can cause various environmental problems. Therefore, development of high-efficiency and clean energy has become the demand of modern society. As a kind of clean energy, nuclear energy has attracted much attention, and various nuclear energy systems including pressurized water reactors, boiling water reactors, and sodium-cooled fast reactors are constantly developing.

Fluoride-salt-cooled high-temperature reactor combines the advantages of Generation IV advanced nuclear reactors such as molten salt reactors, high-temperature gas-cooled reactors, and sodium-cooled fast reactors. It is capable of high-temperature low-pressure operation, inherent safety and compact structure, which is suitable for building a small, lightweight and low-cost modular fluoride-salt-cooled high-temperature reactor for high-efficiency power generation. Meanwhile, it is suitable for underground construction and has good concealment, which can provide integrated energy solutions for national defense bases and improve the survival and combat effectiveness. In addition, the reactor can output high-temperature process heat of above 700° C. for high-temperature hydrogen production, saltwater desalination, mineral mining, etc.

Conventionally, pre-research work on small modular fluoride-salt-cooled high-temperature reactors has been carried out steadily. However, due to a series of system designs and configurations such as multipurpose energy supply methods, energy storage/conversion and comprehensive utilization systems, and specially designed passive residual heat removal systems, there is still no detailed overall planning and technical route. Therefore, from the aspect of application such as generation capacity, energy storage, conversion and utilization of the small modular fluoride-salt-cooled high-temperature reactor, to the aspect of design and cooperative operation such as reactor body, energy storage system and energy conversion system, complete system configurations and technical solutions are required to support the design and construction of the multipurpose integrated energy solution system, thereby promoting the development and utilization of nuclear energy.

### SUMMARY OF THE PRESENT INVENTION

In order to overcome the above defects in the prior art, an object of the present invention is to provide a multipurpose small modular fluoride-salt-cooled high-temperature reactor energy system, having a highly compact scheme and a comprehensive utilization scheme. Both schemes can realize miniaturization, modularization, and high-efficiency power generation of the reactor. The comprehensive utilization scheme can output high-temperature process heat of above 700° C. for multi-stage utilization and storage of energy as well as high-temperature hydrogen production, mineral mining, etc.

Accordingly, in order to accomplish the above objects, the present invention provides:

a multipurpose small modular fluoride-salt-cooled high-temperature reactor energy system, comprising: a reactor body system (1), a passive residual heat removal system (2), a compact supercritical carbon dioxide Brayton cycle system (3), a secondary loop system (4), and a comprehensive utilization supercritical carbon dioxide Brayton cycle system (5);

wherein the reactor body system (1) is a heat source of the multipurpose small modular fluoride-salt-cooled high-temperature reactor energy system, which comprises a reactor vessel (1-1), a core active area (1-2) in the reactor vessel (1-1), a reactor control rod and driving mechanism (1-3), a FLiBe—CO₂ main heat exchanger (1-4), a FLiBe—FLiNaK main heat exchanger (1-5), a first FLiBe—FLiNaK residual heat removal heat exchange (1-6), a second FLiBe—FLiNaK residual heat removal heat exchanger (1-7), a first axial flow main pump (1-8), a second axial flow main pump (1-9), a core baffle (1-10), a radial reflector (1-11), and an axial reflector (1-12); wherein the FLiBe—CO₂ main heat exchanger (1-4), the FLiBe—FLiNaK main heat exchanger (1-5), the first FLiBe-FLiNaK residual heat removal heat exchanger (1-6) and the second FLiBe—FLiNaK residual heat removal heat exchanger (1-7) are located at atop portion of the reactor vessel (1-1); the first axial flow pump (1-8) is located at a bottom portion of the FLiBe—CO₂ main heat exchanger (1-4), and the second axial flow main pump (1-9) is located at a bottom portion of the FLiBe—FLiNaK main heat exchanger (1-5); the control rod and driving mechanism (1-3) is located at a top portion of the core active area (1-2); the core baffle (1-10) is arranged outside the radial reflector (1-11), and the radial reflector (1-11) is circumferentially arranged on the core active area (1-2); the axial reflector (1-12) is arranged at the top portion and a bottom portion of the core active area (1-2);

when the reactor body system (1) is in normal operation, a coolant is driven by the first axial flow pump (1-8) and the second axial flow pump (1-9) to flow from a bottom of the reactor vessel (1-1) to the core active area (1-2); then the coolant flows upwards and passes through the core active area (1-2) to absorb heat before flowing downwards and passing through the first FLiBe—FLiNaK residual heat removal heat exchanger (1-6) and the second FLiBe—FLiNaK residual heat removal heat exchanger (1-7) to release the heat; finally, the coolant enters the first axial flow pump (1-8) and the second axial flow pump (1-9) to be pressurized and complete an in-core coolant cycle;

the passive residual heat removal system (2) is a dedicated safety facility for the multipurpose small modular fluoride-salt-cooled high-temperature reactor energy system, which shares the first FLiBe—FLiNaK residual heat removal heat exchanger (1-6) and the second FLiBe—FLiNaK residual heat removal heat exchanger (1-7) with the reactor body system (1); the passive residual heat removal system (2) further comprises an air cooling tower (2-3), a first air heat exchanger (2-1) located in the air cooling tower (2-3), a second air heat exchanger (2-2), and connecting pipes and valves; wherein an outlet of the first FLiBe—FLiNaK residual heat removal heat exchanger (1-6) is connected to an inlet of the first air heat exchanger (2-1), and an outlet of the first air heat exchanger (2-1) is connected to an inlet of the first FLiBe—FLiNaK residual heat removal heat exchanger (1-6);

when the passive residual heat removal system (2) is in operation, under reactor shutdown and accident conditions, FLiNaK salt is heated by the first FLiBe-FLiNaK residual heat removal heat exchanger (1-6) and is driven into the first air heat exchanger (2-1) by buoyancy; then the FLiNaK salt is cooled by air, flows out of the first air heat exchanger (2-1) and enters the first FLiBe—FLiNaK residual heat removal heat exchanger (1-6) to complete a natural cycle; the second FLiBe—FLiNaK residual heat removal heat exchanger (1-7) and the second air heat exchanger (2-2) work similarly to the first FLiBe—FLiNaK residual heat removal heat exchanger (1-6) and the first air heat exchanger (2-1);

the compact supercritical carbon dioxide Brayton cycle system (3) is an energy conversion module of the multipurpose small modular fluoride-salt-cooled high-temperature reactor energy system, and shares the FLiBe—CO₂ main heat exchanger (1-4) with the reactor body system (1); the compact supercritical carbon dioxide Brayton cycle system (3) further comprises a first turbine (3-1), a first high-temperature regenerator (3-2), a first low-temperature regenerator (3-3), a first diverter valve (3-4), a first cold end heat exchanger (3-5), a first main compressor (3-6), a first auxiliary compressor (3-7), a first confluence valve (3-8), and connecting pipes and valves; wherein an outlet of the FLiBe—CO₂ main heat exchanger (1-4) is connected to an inlet of the first turbine (3-1), and an outlet of the first turbine (3-1) is connected to a hot-side inlet of the first high-temperature regenerator (3-2); a hot-side outlet of the first high-temperature regenerator (3-2) is connected to a hot-side inlet of the first low-temperature regenerator (3-3), and a hot-side outlet of the first low-temperature regenerator (3-3) is connected to a first diverter valve inlet (3.1); a first diverter valve first outlet (3.2) is connected to an inlet of the first auxiliary compressor (3-7), and an outlet of the first auxiliary compressor (3-7) is connected to a first confluence valve first inlet (3.4); a first diverter valve second outlet (3.3) is connected to an inlet of the first cold end heat exchanger (3-5), and an outlet of the first cold end heat exchanger (3-5) is connected to an inlet of the first main compressor (3-6); an outlet of the first main compressor (3-6) is connected to a cold-side inlet of the first low-temperature regenerator (3-3), and a cold-side outlet of the first low-temperature regenerator (3-3) is connected to a first confluence valve second inlet (3.5); a first confluence valve outlet (3.6) is connected to a cold-side inlet of the first high-temperature regenerator (3-2), and a cold-side outlet of the first high-temperature regenerator (3-2) is connected to an inlet of the FLiBe—CO₂ main heat exchanger (1-4);

when the compact supercritical carbon dioxide Brayton cycle system (3) is in operation, CO₂ is heated by main coolant salt in the FLiBe—CO₂ main heat exchanger (1-4) before entering the first turbine (3-1) to do work; then the CO₂ enters a hot side of the first high-temperature regenerator (3-2) to release heat; then the CO₂ leaves the hot side of the first high-temperature regenerator (3-2) and enters a hot side of the first low-temperature regenerator (3-3) to release heat again; after being split through the first diverter valve (3-4), a part of the CO₂ enters the first auxiliary compressor (3-7) and is compressed before entering the first confluence valve (3-8); the other part of the CO₂ is cooled by the first cold end heat exchanger (3-5) and compressed by the first main compressor (3-6), then enters the first low-temperature regenerator (3-3) to absorb heat before entering the first confluence valve (3-8); the CO₂ from the first low-temperature regenerator (3-3) and the first auxiliary compressor (3-7) is combined at the first confluence valve (3-8), and passes through the first high-temperature regenerator (3-2) to release heat; then the CO₂ enters the FLiBe—CO₂ main heat exchanger (1-4) to be heated again to form a cycle;

the secondary loop system (4) is an intermediate heat exchange and energy storage system of the multipurpose small modular fluoride-salt-cooled high-temperature reactor energy system, which provides thermal energy for the comprehensive utilization supercritical carbon dioxide Brayton cycle system (5); the secondary loop system (4) shares the main FLiBe—FLiNaK heat exchanger (1-5) with the reactor body system (1), and further comprises a secondary loop molten salt pump (4-1), a molten salt pool (4-2), a high-temperature process thermal interface (4-3) arranged in the molten salt pool (4-2), a first FLiNaK—CO₂ heat exchanger (5-1), a second FLiNaK—CO₂ heat exchanger (5-2), a third FLiNaK—CO₂ heat exchanger (5-3), and connecting pipes and valves; wherein an outlet of the FLiBe—FLiNaK main heat exchanger (1-5) is connected to an inlet of the molten salt pool (4-2), and an outlet of the molten salt pool (4-2) is connected to an inlet of the secondary loop molten salt pump (4-1); an outlet of the secondary loop molten salt pump (4-1) is connected to an inlet of the FLiBe—FLiNaK main heat exchanger (1-5);

when the secondary loop system (4) is in operation, the FLiNaK salt is heated in the FLiBe—FLiNaK main heat exchanger (1-5) and then enters the molten salt pool (4-2); in the molten salt pool (4-2), FLiNaK salt outputs high-temperature heat thereof through the high-temperature process thermal interface (4-3) for high-temperature hydrogen production, mineral mining and molten salt energy storage; the first FLiNaK—CO₂ heat exchanger (5-1), the second FLiNaK—CO₂ heat exchanger (5-2) and the third FLiNaK—CO₂ heat exchanger (5-3) absorb heat from the molten salt pool (4-2) to heat the CO₂; after heat releasing in the molten salt pool (4-2), the FLiNaK salt is pressurized by the secondary loop molten salt pump (4-1) and enters the FLiBe-FLiNaK main heat exchanger (1-5) to form a cycle;

the comprehensive utilization supercritical carbon dioxide Brayton cycle system (5) is an energy conversion module of the multipurpose small modular fluoride-salt-cooled high-temperature reactor energy system, which shares the first FLiNaK—CO₂ heat exchanger (5-1), the second FLiNaK—CO₂ heat exchanger (5-2) and the third FLiNaK—CO₂ heat exchanger (5-3) with the molten salt pool (4-2) of the secondary loop system (4); the comprehensive utilization supercritical carbon dioxide Brayton cycle system (5) further comprises a second turbine (5-4), a third turbine (5-5), a fourth turbine (5-6), a second low-temperature regenerator (5-7), a first medium-temperature regenerator (5-8), a second high-temperature regenerator (5-9), a second auxiliary compressor (5-10), a second main compressor (5-11), a third main compressor (5-12), a second cold end heat exchanger (5-13), a third cold end heat exchanger (5-14), a second diverter valve (5-15), a second confluence valve (5-16), a third diverter valve (5-17), a third confluence valve (5-18), and connecting pipes and valves; wherein a second diverter valve first outlet (5.2) is connected to a cold-side inlet of the second high-temperature regenerator (5-9), and a cold-side outlet of the second high-temperature regenerator (5-9) is connected to an inlet of the second FLiNaK—CO₂ heat exchanger (5-2); an outlet of the second FLiNaK—CO₂ heat to exchanger (5-2) is connected to an inlet of the first turbine (5-4), and an outlet of the first turbine (5-4) is connected to an inlet of the third FLiNaK—CO₂ heat exchanger (5-3); an outlet of the third FLiNaK—CO₂ heat exchanger (5-3) is connected to an inlet of the second turbine (5-5), and an outlet of the second turbine (5-5) outlet is connected to a hot-side inlet of the second high-temperature regenerator (5-9); a hot-side outlet of the second high-temperature regenerator (5-9) is connected to a second confluence valve first inlet (5.4), and a second diverter valve second outlet (5.3) is connected to an inlet of the first FLiNaK—CO₂ heat exchanger (5-1); an outlet of the first FLiNaK—CO₂ heat exchanger (5-1) is connected to an inlet of the fourth turbine (5-6), and an outlet of the fourth turbine (5-6) is connected to a second confluence valve second inlet (5.5); a second confluence valve outlet (5.6) is connected to a hot-side inlet of the first medium-temperature regenerator (5-8), and a hot-side outlet of the first medium-temperature regenerator (5-8) is connected to a hot-side inlet of the second low-temperature regenerator (5-7); a hot-side outlet of the second low-temperature regenerator (5-7) is connected to a third diverter valve inlet (5.7), and a third diverter valve first outlet (5.8) is connected to an inlet of the second auxiliary compressor (5-10); an outlet of the second auxiliary compressor (5-10) is connected to a third confluence valve first inlet (5.10), and a third diverter valve second outlet (5.9) is connected to an inlet of the second cold end heat exchanger (5-13); an outlet of the second cold end heat exchanger (5-13) is connected to an inlet of the second main compressor (5-11), and an outlet of the second main compressor (5-11) is connected to an inlet of the third cold end heat exchanger (5-14); an outlet of the third cold end heat exchanger (5-14) is connected to an inlet of the third main compressor (5-12), and an outlet of the third main compressor (5-12) is connected to a cold-side inlet of the second low-temperature regenerator (5-7); a cold-side outlet of the second low-temperature regenerator (5-7) is connected to a third confluence valve second inlet (5.11), and a third confluence valve outlet (5.12) is connected to a cold-side inlet of the first medium-temperature regenerator (5-8); a cold-side outlet of the first medium-temperature regenerator (5-8) is connected to a second diverter valve inlet (5.1);

when the comprehensive utilization supercritical carbon dioxide Brayton cycle system (5) is in operation, after being split through the second diversion valve (5-15), a part of CO₂ from a cold side of the first medium-temperature regenerator (5-8) enters a cold side of the second high-temperature regenerator (5-9) to absorb heat, and then enters the second FLiNaK—CO₂ heat exchanger (5-2) to be heated before doing work in the second turbine (5-4); then the CO₂ enters the third FLiNaK—CO₂ heat exchanger (5-3) to be heated, and enters the third turbine (5-5) to do work before releasing heat in a hot side of the second high-temperature regenerator (5-9); the other part of the CO₂ from the cold side of the first medium-temperature regenerator (5-8) enters the first FLiNaK—CO₂ heat exchanger (5-1) to release heat, and enters the fourth turbine (5-6) to do work; the CO₂ from the fourth turbine (5-6) and the hot side of the second high-temperature regenerator (5-9) is combined at the second confluence valve (5-16) and enters a hot side of the first medium-temperature regenerator confluence (5-8) to release heat, and then enters a hot side of the second low-temperature regenerator (5-7) to release heat; after being split through the third diverter valve (5-17), a part of the CO₂ is compressed and pressurized by the second auxiliary compressor (5-10), and the other part of the CO₂ is cooled by the second cold end heat exchanger (5-13) and enters the second main compressor (5-11) to be compressed and pressurized, and then is cooled by the third cold end heat exchanger (5-14) and enters the third main compressor (5-12) to be compressed and pressurized; the two parts of the CO₂ is combined at the third confluence valve (5-18) and enters a cold side of the first medium-temperature regenerator (5-8) to absorb heat, then enters the second diverter valve (5-15) to form a cycle.

A thermal power of the core active area (1-2) of the reactor body system (1) is 125 MW, a core inlet temperature is 650° C., and a core outlet temperature is 700° C.; FLiBe salt is used as the coolant; mole fractions of LiF and BeF₂ are 67% and 33% respectively; the passive residual heat removal system (2) and the secondary loop system (4) adopts the FLiNaK salt as a cooling medium; mole fractions of LiF, NaF and KF are 46.5%, 11.5% and 42% respectively.

The core active area (1-2) of the reactor body system (1) adopts helical cruciform fuel elements; TRISO nuclear fuel is dispersed in a matrix with a filling rate of 50%; enrichment of ²³⁵U nuclear fuel is 15% and 17.5%; fuel rods are arranged triangularly in each of the fuel elements, and the fuel elements are also arranged triangularly.

The main FLiBe—CO₂ heat exchanger (1-4) of the reactor body system (1), as well as the first FLiNaK—CO₂ heat exchanger (5-1), the second FLiNaK—CO₂ heat exchanger (5-2) and the third FLiNaK—CO₂ heat exchanger (5-3) of the comprehensive utilization supercritical carbon dioxide Brayton cycle system (5), are all printed circuit heat exchangers; the FLiBe—FLiNaK main heat exchanger (1-5) of the reactor body system (1), as well as the first FLiBe—FLiNaK residual heat removal heat exchanger (1-6) and the second FLiBe—FLiNaK residual heat removal heat exchanger (1-7) of the passive residual heat removal system (2), are all shell-and-tube heat exchangers.

A thermal efficiency of the compact supercritical carbon dioxide Brayton cycle system (3) is above 48%, and a thermal efficiency of the comprehensive utilization supercritical carbon dioxide Brayton cycle system (5) is above 54%.

The reactor vessel (1-1) of the reactor body system (1) has a diameter of less than 3.5 m and a height of less than 3 m.

The compact supercritical carbon dioxide Brayton cycle system (3) and an energy conversion system formed by the secondary loop system (4) and the comprehensive utilization supercritical carbon dioxide Brayton cycle system (5) are not used synchronically, and are switched according to demands.

Compared with the prior art, the present invention has the following advantages:

1. The small modular fluoride-salt-cooled high-temperature reactor is combined with the compact supercritical carbon dioxide Brayton cycle system, so as to realize efficient and compact utilization of energy. The small modular fluoride-salt-cooled high-temperature reactor is combined with the secondary loop system and the comprehensive utilization supercritical carbon dioxide Brayton cycle system, so as to meet the needs of multiple purposes, integrated production, storage and conversion of energy.

2. The reactor uses the FLiBe salt as the coolant, which has the advantages of high temperature, low pressure and compact structure. The boiling point of the FLiBe salt is higher than 1000° C. and the freezing point is lower than 500° C. The operating pressure is 0.2 MPa, which is much lower than 15.5 MPa for pressurized water reactors and 3-7 MPa for gas-cooled reactors, thereby effectively reducing the probability of rupture accident in the primary circuit. Compared with conventional nuclear reactor coolants, the FLiBe salt has higher heat-carrying performance, and its volumetric heat capacity is 1.16, 2.75, 4.49, and 233.5 times of water, liquid lead-bismuth alloy, liquid metal sodium, and helium, respectively. The FLiBe salt can take away more heat under the same coolant volume, which is beneficial to reduce the volume of the reactor vessel.

3. Inherent safety is high. The reactor adopts a helical cruciform fuel element, and such structure can enhance the heat exchange of the coolant. The TRISO nuclear fuel is dispersed in a graphite matrix to accommodate fission gas and fission products, and a failure temperature thereof is higher than 1600° C. The passive residual heat removal system is driven by buoyancy, and no external energy is required.

4. The present invention has a high economical potential. The TRISO nuclear fuel can achieve a high burnup level, thereby improving fuel utilization. The molten salt pool of the multipurpose small modular fluoride-salt-cooled high-temperature reactor energy system provides a high-temperature process heat of about 700° C. for high-temperature hydrogen production, mineral mining, molten salt energy storage, etc.

5. Modular technology is used. Most devices of the present invention can be modularly fabricated, manufactured, transported and installed. Through modular technology, the construction time can be shortened, the economic efficiency is high, and the application scheme is more flexible.

6. Thermal efficiency is high, power is sufficient, and power response is rapid. Compared with the conventional Rankine cycle, the supercritical carbon dioxide Brayton cycle system has high thermal efficiency, compact structure, flexible control and rapid response. Through design and calculation, the thermal efficiency of the compact supercritical carbon dioxide Brayton cycle system of the present invention is above 48%, and the thermal efficiency of the comprehensive utilization supercritical carbon dioxide Brayton cycle system is above 54%. Both cycle systems can be used or not according to task requirements.

### BRIEF DESCRIPTION OF THE DRAWINGS

FIGURE is a system structural view of the present invention, including instruction of inlets and outlets of diverter valves and confluence valves.

### ELEMENT REFERENCE

1: Reactor body system
1-1: Reactor vessel; 1-2: Core active area; 1-3: Reactor control rod and driving mechanism; 1-4: FLiBe—CO₂ main heat exchanger; 1-5: FLiBe—FLiNaK main heat exchanger; 1-6: First FLiBe—FLiNaK residual heat removal heat exchanger; 1-7: Second FLiBe—FLiNaK residual heat removal heat exchanger; 1-8: First axial flow main pump; 1-9: Second axial flow main pump; 1-10: Core baffle; 1-11: Radial reflector; 1-12: Axial reflector;
2: Passive residual heat removal system
2-1: First air heat exchanger; 2-2: Second air heat exchanger; 2-3: Air cooling tower;
3: Compact supercritical carbon dioxide Brayton cycle system;
3-1: First turbine; 3-2: First high-temperature regenerator; 3-3: First low-temperature regenerator; 3-4: First diverter valve; 3-5: First cold end heat exchange; 3-6: First main compressor; 3-7: First auxiliary compressor; 3-8: First confluence valve;
4: Secondary loop system
4-1: Secondary loop molten salt pump; 4-2: Molten salt pool; 4-3: High-temperature process thermal interface;
5: Comprehensive utilization supercritical carbon dioxide Brayton cycle system
5-1: First FLiNaK—CO₂ heat exchanger; 5-2: Second FLiNaK—CO₂ heat exchanger; 5-3: Third FLiNaK—CO₂ heat exchanger; 5-4: Second turbine; 5-5 : Third turbine; 5-6: Fourth turbine; 5-7: Second low-temperature regenerator; 5-8: First medium-temperature regenerator; 5-9: Second high-temperature regenerator; 5-10: Second auxiliary compressor; 5-11: Second main compressor; 5-12: Third main compressor; 5-13: Second cold end heat exchanger; 5-14: Third cold end heat exchange; 5-15: Second diverter valve; 5-16: Second confluence valve; 5-17: Third diverter valve; 5-18: Third confluence valve;
3.1: First diverter valve inlet; 3.2: First diverter valve first outlet; 3.3: First diverter valve second outlet; 3.4: First confluence valve first inlet; 3.5: First confluence valve second inlet; 3.6: First confluence valve outlet; 5.1: Second diverter valve inlet; 5.2: Second diverter valve first outlet; 5.3: Second diverter valve second outlet; 5.4: Second confluence valve first inlet; 5.5: Second confluence valve second inlet; 5.6: Second confluence valve outlet; 5.7: Third diverter valve inlet; 5.8: Third diverter valve first outlet; 5.9: Third diverter valve second outlet; 5.10: Third confluence valve first inlet; 5.11: Third confluence valve second inlet; 5.12: Third confluence valve outlet.

### DETAILED DESCRIPTION OF THE PREFERRED EMBODIMENT

The present invention provides a multipurpose small modular fluoride-salt-cooled high-temperature reactor energy system, which will be further illustrated with accompanying drawing.

Referring to FIGURE, the multipurpose small modular fluoride-salt-cooled high-temperature reactor energy system comprises: a reactor body system 1, a passive residual heat removal system 2, a compact supercritical carbon dioxide Brayton cycle system 3, a secondary loop system 4, and a comprehensive utilization supercritical carbon dioxide Brayton cycle system 5;

wherein the reactor body system 1 is a heat source of the multipurpose small modular fluoride-salt-cooled high-temperature reactor energy system, which comprises a reactor vessel 1-1, a core active area 1-2 in the reactor vessel 1-1, a reactor control rod and driving mechanism 1-3, a FLiBe—CO₂ main heat exchanger 1-4, a FLiBe—FLiNaK main heat exchanger 1-5, a first FLiBe—FLiNaK residual heat removal heat exchange 1-6, a second FLiBe—FLiNaK residual heat removal heat exchanger 1-7, a first axial flow main pump 1-8, a second axial flow main pump 1-9, a core baffle 1-10, a radial reflector 1-11, and an axial reflector 1-12; wherein the FLiBe—CO₂ main heat exchanger 1-4, the FLiBe—FLiNaK main heat exchanger 1-5, the first FLiBe—FLiNaK residual heat removal heat exchanger 1-6 and the second FLiBe—FLiNaK residual heat removal heat exchanger 1-7 are located at a top portion of the reactor vessel 1-1; the first axial flow pump 1-8 is located at a bottom portion of the FLiBe—CO₂ main heat exchanger 1-4, and the second axial flow main pump 1-9 is located at a bottom portion of the FLiBe—FLiNaK main heat exchanger 1-5; the control rod and driving mechanism 1-3 is located at a top portion of the core active area 1-2; the core baffle 1-10 is arranged outside the radial reflector 1-11, and the radial reflector 1-11 is circumferentially arranged on the core active area 1-2; the axial reflector 1-12 is arranged at the top portion and a bottom portion of the core active area 1-2;

when the reactor body system 1 is in normal operation, a coolant is driven by the first axial flow pump 1-8 and the second axial flow pump 1-9 to flow from a bottom of the reactor vessel 1-1 to the core active area 1-2; then the coolant flows upwards and passes through the core active area 1-2 to absorb heat before flowing downwards and passing through the first FLiBe—FLiNaK residual heat removal heat exchanger 1-6 and the second FLiBe—FLiNaK residual heat removal heat exchanger 1-7 to release the heat; finally, the coolant enters the first axial flow pump 1-8 and the second axial flow pump 1-9 to be pressurized and complete an in-core coolant cycle;

the passive residual heat removal system 2 is a dedicated safety facility for the multipurpose small modular fluoride-salt-cooled high-temperature reactor energy system, which shares the first FLiBe—FLiNaK residual heat removal heat exchanger 1-6 and the second FLiBe—FLiNaK residual heat removal heat exchanger 1-7 with the reactor body system 1; the passive residual heat removal system 2 further comprises an air cooling tower 2-3, a first air heat exchanger 2-1 located in the air cooling tower 2-3, a second air heat exchanger 2-2, and connecting pipes and valves; wherein an outlet of the first FLiBe—FLiNaK residual heat removal heat exchanger 1-6 is connected to an inlet of the first air heat exchanger 2-1, and an outlet of the first air heat exchanger 2-1 is connected to an inlet of the first FLiBe—FLiNaK residual heat removal heat exchanger 1-6;

when the passive residual heat removal system 2 is in operation, under reactor shutdown and accident conditions, FLiNaK salt is heated by the first FLiBe—FLiNaK residual heat removal heat exchanger 1-6 and is driven into the first air heat exchanger 2-1 by buoyancy; then the FLiNaK salt is cooled by air, flows out of the first air heat exchanger 2-1 and enters the first FLiBe—FLiNaK residual heat removal heat exchanger 1-6 to complete a natural cycle; the second FLiBe—FLiNaK residual heat removal heat exchanger 1-7 and the second air heat exchanger 2-2 work similarly to the first FLiBe—FLiNaK residual heat removal heat exchanger 1-6 and the first air heat exchanger 2-1;

the compact supercritical carbon dioxide Brayton cycle system 3 is an energy conversion module of the multipurpose small modular fluoride-salt-cooled high-temperature reactor energy system, and shares the FLiBe—CO₂ main heat exchanger 1-4 with the reactor body system 1; the compact supercritical carbon dioxide Brayton cycle system 3 further comprises a first turbine 3-1, a first high-temperature regenerator 3-2, a first low-temperature regenerator 3-3, a first diverter valve 3-4, a first cold end heat exchanger 3-5, a first main compressor 3-6, a first auxiliary compressor 3-7, a first confluence valve 3-8, and connecting pipes and valves; wherein an outlet of the FLiBe—CO₂ main heat exchanger 1-4 is connected to an inlet of the first turbine 3-1, and an outlet of the first turbine 3-1 is connected to a hot-side inlet of the first high-temperature regenerator 3-2; a hot-side outlet of the first high-temperature regenerator 3-2 is connected to a hot-side inlet of the first low-temperature regenerator 3-3, and a hot-side outlet of the first low-temperature regenerator 3-3 is connected to a first diverter valve inlet 3.1; a first diverter valve first outlet 3.2 is connected to an inlet of the first auxiliary compressor 3-7, and an outlet of the first auxiliary compressor 3-7 is connected to a first confluence valve first inlet 3.4; a first diverter valve second outlet 3.3 is connected to an inlet of the first cold end heat exchanger 3-5, and an outlet of the first cold end heat exchanger 3-5 is connected to an inlet of the first main compressor 3-6; an outlet of the first main compressor 3-6 is connected to a cold-side inlet of the first low-temperature regenerator 3-3, and a cold-side outlet of the first low-temperature regenerator 3-3 is connected to a first confluence valve second inlet 3.5; a first confluence valve outlet 3.6 is connected to a cold-side inlet of the first high-temperature regenerator 3-2, and a cold-side outlet of the first high-temperature regenerator 3-2 is connected to an inlet of the FLiBe—CO₂ main heat exchanger 1-4;

when the compact supercritical carbon dioxide Brayton cycle system 3 is in operation, CO₂ is heated by main coolant salt in the FLiBe—CO₂ main heat exchanger 1-4 before entering the first turbine 3-1 to do work; then the CO₂ enters a hot side of the first high-temperature regenerator 3-2 to release heat; then the CO₂ leaves the hot side of the first high-temperature regenerator 3-2 and enters a hot side of the first low-temperature regenerator 3-3 to release heat again; after being split through the first diverter valve 3-4, a part of the CO₂ enters the first auxiliary compressor 3-7 and is compressed before entering the first confluence valve 3-8; the other part of the CO₂ is cooled by the first cold end heat exchanger 3-5 and compressed by the first main compressor 3-6, then enters the first low-temperature regenerator 3-3 to absorb heat before entering the first confluence valve 3-8; the CO₂ from the first low-temperature regenerator 3-3 and the first auxiliary compressor 3-7 is combined at the first confluence valve 3-8, and passes through the first high-temperature regenerator 3-2 to release heat; then the CO₂ enters the FLiBe—CO₂ main heat exchanger 1-4 to be heated again to form a cycle;

the secondary loop system 4 is an intermediate heat exchange and energy storage system of the multipurpose small modular fluoride-salt-cooled high-temperature reactor energy system, which provides thermal energy for the comprehensive utilization supercritical carbon dioxide Brayton cycle system 5; the secondary loop system 4 shares the main FLiBe—FLiNaK heat exchanger 1-5 with the reactor body system 1, and further comprises a secondary loop molten salt pump 4-1, a molten salt pool 4-2, a high-temperature process thermal interface 4-3 arranged in the molten salt pool 4-2, a first FLiNaK—CO₂ heat exchanger 5-1, a second FLiNaK—CO₂ heat exchanger 5-2, a third FLiNaK—CO₂ heat exchanger 5-3, and connecting pipes and valves; wherein an outlet of the FLiBe—FLiNaK main heat exchanger 1-5 is connected to an inlet of the molten salt pool 4-2, and an outlet of the molten salt pool 4-2 is connected to an inlet of the secondary loop molten salt pump 4-1; an outlet of the secondary loop molten salt pump 4-1 is connected to an inlet of the FLiBe—FLiNaK main heat exchanger 1-5;

when the secondary loop system 4 is in operation, the FLiNaK salt is heated in the FLiBe—FLiNaK main heat exchanger 1-5 and then enters the molten salt pool 4-2; in the molten salt pool 4-2, FLiNaK salt outputs high-temperature heat thereof through the high-temperature process thermal interface 4-3 for high-temperature hydrogen production, mineral mining and molten salt energy storage; the first FLiNaK—CO₂ heat exchanger 5-1, the second FLiNaK—CO₂ heat exchanger 5-2 and the third FLiNaK—CO₂ heat exchanger 5-3 absorb heat from the molten salt pool 4-2 to heat the CO₂; after heat releasing in the molten salt pool 4-2, the FLiNaK salt is pressurized by the secondary loop molten salt pump 4-1 and enters the FLiBe—FLiNaK main heat exchanger 1-5 to form a cycle;

the comprehensive utilization supercritical carbon dioxide Brayton cycle system 5 is an energy conversion module of the multipurpose small modular fluoride-salt-cooled high-temperature reactor energy system, which shares the first FLiNaK—CO₂ heat exchanger 5-1, the second FLiNaK—CO₂ heat exchanger 5-2 and the third FLiNaK—CO₂ heat exchanger 5-3 with the molten salt pool 4-2 of the secondary loop system 4; the comprehensive utilization supercritical carbon dioxide Brayton cycle system 5 further comprises a second turbine 5-4, a third turbine 5-5, a fourth turbine 5-6, a second low-temperature regenerator 5-7, a first medium-temperature regenerator 5-8, a second high-temperature regenerator 5-9, a second auxiliary compressor 5-10, a second main compressor 5-11, a third main compressor 5-12, a second cold end heat exchanger 5-13, a third cold end heat exchanger 5-14, a second diverter valve 5-15, a second confluence valve 5-16, a third diverter valve 5-17, a third confluence valve 5-18, and connecting pipes and valves; wherein a second diverter valve first outlet 5.2 is connected to a cold-side inlet of the second high-temperature regenerator 5-9, and a cold-side outlet of the second high-temperature regenerator 5-9 is connected to an inlet of the second FLiNaK—CO₂ heat exchanger 5-2; an outlet of the second FLiNaK—CO₂ heat exchanger 5-2 is connected to an inlet of the first turbine 5-4, and an outlet of the first turbine 5-4 is connected to an inlet of the third FLiNaK—CO₂ heat exchanger 5-3; an outlet of the third FLiNaK—CO₂ heat exchanger 5-3 is connected to an inlet of the second turbine 5-5, and an outlet of the second turbine 5-5 outlet is connected to a hot-side inlet of the second high-temperature regenerator 5-9; a hot-side outlet of the second high-temperature regenerator 5-9 is connected to a second confluence valve first inlet 5.4, and a second diverter valve second outlet 5.3 is connected to an inlet of the first FLiNaK—CO₂ heat exchanger 5-1; an outlet of the first FLiNaK—CO₂ heat exchanger 5-1 is connected to an inlet of the fourth turbine 5-6, and an outlet of the fourth turbine 5-6 is connected to a second confluence valve second inlet 5.5; a second confluence valve outlet 5.6 is connected to a hot-side inlet of the first medium-temperature regenerator 5-8, and a hot-side outlet of the first medium-temperature regenerator 5-8 is connected to a hot-side inlet of the second low-temperature regenerator 5-7; a hot-side outlet of the second low-temperature regenerator 5-7 is connected to a third diverter valve inlet 5.7, and a third diverter valve first outlet 5.8 is connected to an inlet of the second auxiliary compressor 5-10; an outlet of the second auxiliary compressor 5-10 is connected to a third confluence valve first inlet 5.10, and a third diverter valve second outlet 5.9 is connected to an inlet of the second cold end heat exchanger 5-13; an outlet of the second cold end heat exchanger 5-13 is connected to an inlet of the second main compressor 5-11, and an outlet of the second main compressor 5-11 is connected to an inlet of the third cold end heat exchanger 5-14; an outlet of the third cold end heat exchanger 5-14 is connected to an inlet of the third main compressor 5-12, and an outlet of the third main compressor 5-12 is connected to a cold-side inlet of the second low-temperature regenerator 5-7; a cold-side outlet of the second low-temperature regenerator 5-7 is connected to a third confluence valve second inlet 5.11, and a third confluence valve outlet 5.12 is connected to a cold-side inlet of the first medium-temperature regenerator 5-8; a cold-side outlet of the first medium-temperature regenerator 5-8 is connected to a second diverter valve inlet 5.1;

when the comprehensive utilization supercritical carbon dioxide Brayton cycle system 5 is in operation, after being split through the second diversion valve 5-15, a part of CO₂ from a cold side of the first medium-temperature regenerator 5-8 enters a cold side of the second high-temperature regenerator 5-9 to absorb heat, and then enters the second FLiNaK—CO₂ heat exchanger 5-2 to be heated before doing work in the second turbine 5-4; then the CO₂ enters the third FLiNaK—CO₂ heat exchanger 5-3 to be heated, and enters the third turbine 5-5 to do work before releasing heat in a hot side of the second high-temperature regenerator 5-9; the other part of the CO₂ from the cold side of the first medium-temperature regenerator 5-8 enters the first FLiNaK—CO₂ heat exchanger 5-1 to release heat, and enters the fourth turbine 5-6 to do work; the CO₂ from the fourth turbine 5-6 and the hot side of the second high-temperature regenerator 5-9 is combined at the second confluence valve 5-16 and enters a hot side of the first medium-temperature regenerator confluence 5-8 to release heat, and then enters a hot side of the second low-temperature regenerator 5-7 to release heat; after being split through the third diverter valve 5-17, a part of the CO₂ is compressed and pressurized by the second auxiliary compressor 5-10, and the other part of the CO₂ is cooled by the second cold end heat exchanger 5-13 and enters the second main compressor 5-11 to be compressed and pressurized, and then is cooled by the third cold end heat exchanger 5-14 and enters the third main compressor 5-12 to be compressed and pressurized; the two parts of the CO₂ is combined at the third confluence valve 5-18 and enters a cold side of the first medium-temperature regenerator 5-8 to absorb heat, then enters the second diverter valve 5-15 to form a cycle.

Preferably, a thermal power of the core active area 1-2 of the reactor body system 1 is 125 MW, a core inlet temperature is 650° C., and a core outlet temperature is 700° C.; FLiBe salt is used as the coolant; mole fractions of LiF and BeF₂ are 67% and 33% respectively; the passive residual heat removal system 2 and the secondary loop system 4 adopts the FLiNaK salt as a cooling medium; mole fractions of LiF, NaF and KF are 46.5%, 11.5% and 42% respectively.

Preferably, the core active area 1-2 of the reactor body system 1 adopts helical cruciform fuel elements; TRISO nuclear fuel is dispersed in a matrix with a filling rate of 50%; enrichment of ²³⁵U nuclear fuel is 15% and 17.5%; fuel rods are arranged triangularly in each of the fuel elements, and the fuel elements are also arranged triangularly.

Preferably, the main FLiBe—CO₂ heat exchanger 1-4 of the reactor body system 1, as well as the first FLiNaK—CO₂ heat exchanger 5-1, the second FLiNaK—CO₂ heat exchanger 5-2 and the third FLiNaK—CO₂ heat exchanger 5-3 of the comprehensive utilization supercritical carbon dioxide Brayton cycle system 5, are all printed circuit heat exchangers; the FLiBe—FLiNaK main heat exchanger 1-5 of the reactor body system 1, as well as the first FLiBe—FLiNaK residual heat removal heat exchanger 1-6 and the second FLiBe—FLiNaK residual heat removal heat exchanger 1-7 of the passive residual heat removal system 2, are all shell-and-tube heat exchangers.

Preferably, a thermal efficiency of the compact supercritical carbon dioxide Brayton cycle system 3 is above 48%, and a thermal efficiency of the comprehensive utilization supercritical carbon dioxide Brayton cycle system 5 is above 54%.

Preferably, the reactor vessel 1-1 of the reactor body system 1 has a diameter of less than 3.5 m and a height of less than 3 m.

Preferably, the compact supercritical carbon dioxide Brayton cycle system 3 and an energy conversion system formed by the secondary loop system 4 and the comprehensive utilization supercritical carbon dioxide Brayton cycle system 5 are not used synchronically, and are switched according to demands.

The present invention has been fully described above in conjunction with the preferred embodiment, but are not limited thereto. To those skilled in the art, without departing from the concept of the present invention, some simple deductions or substitutions can be made, which should also be regarded as falling into the protection scope defined by the appended of the present invention.

What is claimed is:

1. A multipurpose small modular fluoride-salt-cooled high-temperature reactor energy system, comprising: a reactor body system (1), a passive residual heat removal system (2), a compact supercritical carbon dioxide Brayton cycle system (3), a secondary loop system (4), and a comprehensive utilization supercritical carbon dioxide Brayton cycle system (5);
wherein the reactor body system (1) is a heat source of the multipurpose small modular fluoride-salt-cooled high-temperature reactor energy system, which comprises a reactor vessel (1-1), a core active area (1-2) in the reactor vessel (1-1), a reactor control rod and driving mechanism (1-3), a FLiBe—CO₂ main heat exchanger (1-4), a FLiBe—FLiNaK main heat exchanger (1-5), a first FLiBe—FLiNaK residual heat removal heat exchange (1-6), a second FLiBe—FLiNaK residual heat removal heat exchanger (1-7), a first axial flow main pump (1-8), a second axial flow main pump (1-9), a core baffle (1-10), a radial reflector (1-11), and an axial reflector (1-12); wherein the FLiBe—CO₂ main heat exchanger (1-4), the FLiBe—FLiNaK main heat exchanger (1-5), the first FLiBe—FLiNaK residual heat removal heat exchanger (1-6) and the second FLiBe—FLiNaK residual heat removal heat exchanger (1-7) are located at a top portion of the reactor vessel (1-1); the first axial flow pump (1-8) is located at a bottom portion of the FLiBe—CO₂ main heat exchanger (1-4), and the second axial flow main pump (1-9) is located at a bottom portion of the FLiBe—FLiNaK main heat exchanger (1-5); the control rod and driving mechanism (1-3) is located at a top portion of the core active area (1-2); the core baffle (1-10) is arranged outside the radial reflector (1-11), and the radial reflector (1-11) is circumferentially arranged on the core active area (1-2); the axial reflector (1-12) is arranged at the top portion and a bottom portion of the core active area (1-2);
when the reactor body system (1) is in normal operation, a coolant is driven by the first axial flow pump (1-8) and the second axial flow pump (1-9) to flow from a bottom of the reactor vessel (1-1) to the core active area (1-2); then the coolant flows upwards and passes through the core active area (1-2) to absorb heat before flowing downwards and passing through the first FLiBe—FLiNaK residual heat removal heat exchanger (1-6) and the second FLiBe—FLiNaK residual heat removal heat exchanger (1-7) to release the heat; finally, the coolant enters the first axial flow pump (1-8) and the second axial flow pump (1-9) to be pressurized and complete an in-core coolant cycle;
the passive residual heat removal system (2) is a dedicated safety facility for the multipurpose small modular fluoride-salt-cooled high-temperature reactor energy system, which shares the first FLiBe—FLiNaK residual heat removal heat exchanger (1-6) and the second FLiBe—FLiNaK residual heat removal heat exchanger (1-7) with the reactor body system (1); the passive residual heat removal system (2) further comprises an air cooling tower (2-3), a first air heat exchanger (2-1) located in the air cooling tower (2-3), a second air heat exchanger (2-2), and connecting pipes and valves; wherein an outlet of the first FLiBe—FLiNaK residual heat removal heat exchanger (1-6) is connected to an inlet of the first air heat exchanger (2-1), and an outlet of the first air heat exchanger (2-1) is connected to an inlet of the first FLiBe—FLiNaK residual heat removal heat exchanger (1-6); an outlet of the second FLiBe—FLiNaK residual heat removal heat exchanger (1-7) is connected to an inlet of the second air heat exchanger (2-2), and an outlet of the second air heat exchanger (2-2) is connected to an inlet of the second FLiBe—FLiNaK residual heat removal heat exchanger (1-7);
when the passive residual heat removal system (2) is in operation, under reactor shutdown and accident conditions, FLiNaK salt is heated by the first FLiBe—FLiNaK residual heat removal heat exchanger (1-6) and is driven into the first air heat exchanger (2-1) by buoyancy; then the FLiNaK salt is cooled by air, flows out of the first air heat exchanger (2-1) and enters the first FLiBe—FLiNaK residual heat removal heat exchanger (1-6) to complete a natural cycle; the second FLiBe—FLiNaK residual heat removal heat exchanger (1-7) and the second air heat exchanger (2-2) work similarly to the first FLiBe—FLiNaK residual heat removal heat exchanger (1-6) and the first air heat exchanger (2-1);
the compact supercritical carbon dioxide Brayton cycle system (3) is an energy conversion module of the multipurpose small modular fluoride-salt-cooled high-temperature reactor energy system, and shares the FLiBe—CO₂ main heat exchanger (1-4) with the reactor body system (1); the compact supercritical carbon dioxide Brayton cycle system (3) further comprises a first turbine (3-1), a first high-temperature regenerator (3-2), a first low-temperature regenerator (3-3), a first diverter valve (3-4), a first cold end heat exchanger (3-5), a first main compressor (3-6), a first auxiliary compressor (3-7), a first confluence valve (3-8), and connecting pipes and valves; wherein an outlet of the FLiBe—CO₂ main heat exchanger (1-4) is connected to an inlet of the first turbine (3-1), and an outlet of the first turbine (3-1) is connected to a hot-side inlet of the first high-temperature regenerator (3-2); a hot-side outlet of the first high-temperature regenerator (3-2) is connected to a hot-side inlet of the first low-temperature regenerator (3-3), and a hot-side outlet of the first low-temperature regenerator (3-3) is connected to a first diverter valve inlet (3.1); a first diverter valve first outlet (3.2) is connected to an inlet of the first auxiliary compressor (3-7), and an outlet of the first auxiliary compressor (3-7) is connected to a first confluence valve first inlet (3.4); a first diverter valve second outlet (3.3) is connected to an inlet of the first cold end heat exchanger (3-5), and an outlet of the first cold end heat exchanger (3-5) is connected to an inlet of the first main compressor (3-6); an outlet of the first main compressor (3-6) is connected to a cold-side inlet of the first low-temperature regenerator (3-3), and a cold-side outlet of the first low-temperature regenerator (3-3) is connected to a first confluence valve second inlet (3.5); a first confluence valve outlet (3.6) is connected to a cold-side inlet of the first high-temperature regenerator (3-2), and a cold-side outlet of the first high-temperature regenerator (3-2) is connected to an inlet of the FLiBe—CO₂ main heat exchanger (1-4);
when the compact supercritical carbon dioxide Brayton cycle system (3) is in operation, CO₂ is heated by main coolant salt in the FLiBe—CO₂ main heat exchanger (1-4) before entering the first turbine (3-1) to do work; then the CO₂ enters a hot side of the first high-temperature regenerator (3-2) to release heat; then the CO₂ leaves the hot side of the first high-temperature regenerator (3-2) and enters a hot side of the first low-temperature regenerator (3-3) to release heat again; after being split through the first diverter valve (3-4), a part of the CO₂ enters the first auxiliary compressor (3-7) and is compressed before entering the first confluence valve (3-8); the other part of the CO₂ is cooled by the first cold end heat exchanger (3-5) and compressed by the first main compressor (3-6), then enters the first low-temperature regenerator (3-3) to absorb heat before entering the first confluence valve (3-8); the CO₂ from the first low-temperature regenerator (3-3) and the first auxiliary compressor (3-7) is combined at the first confluence valve (3-8), and passes through the first high-temperature regenerator (3-2) to release heat; then the CO₂ enters the FLiBe—CO₂ main heat exchanger (1-4) to be heated again to form a cycle;
the secondary loop system (4) is an intermediate heat exchange and energy storage system of the multipurpose small modular fluoride-salt-cooled high-temperature reactor energy system, which provides thermal energy for the comprehensive utilization supercritical carbon dioxide Brayton cycle system (5); the secondary loop system (4) shares the main FLiBe—FLiNaK heat exchanger (1-5) with the reactor body system (1), and further comprises a secondary loop molten salt pump (4-1), a molten salt pool (4-2), a high-temperature process thermal interface (4-3) arranged in the molten salt pool (4-2), a first FLiNaK—CO₂ heat exchanger (5-1), a second FLiNaK—CO₂ heat exchanger (5-2), a third FLiNaK—CO₂ heat exchanger (5-3), and connecting pipes and valves; wherein an outlet of the FLiBe—FLiNaK main heat exchanger (1-5) is connected to an inlet of the molten salt pool (4-2), and an outlet of the molten salt pool (4-2) is connected to an inlet of the secondary loop molten salt pump (4-1); an outlet of the secondary loop molten salt pump (4-1) is connected to an inlet of the FLiBe—FLiNaK main heat exchanger (1-5);
when the secondary loop system (4) is in operation, the FLiNaK salt is heated in the FLiBe-FLiNaK main heat exchanger (1-5) and then enters the molten salt pool (4-2); in the molten salt pool (4-2), FLiNaK salt outputs high-temperature heat thereof through the high-temperature process thermal interface (4-3) for high-temperature hydrogen production, mineral mining and molten salt energy storage; the first FLiNaK—CO₂ heat exchanger (5-1), the second FLiNaK—CO₂ heat exchanger (5-2) and the third FLiNaK—CO₂ heat exchanger (5-3) absorb heat from the molten salt pool (4-2) to heat the CO₂; after heat releasing in the molten salt pool (4-2), the FLiNaK salt is pressurized by the secondary loop molten salt pump (4-1) and enters the FLiBe—FLiNaK main heat exchanger (1-5) to form a cycle;
the comprehensive utilization supercritical carbon dioxide Brayton cycle system (5) is an energy conversion module of the multipurpose small modular fluoride-salt-cooled high-temperature reactor energy system, which shares the first FLiNaK—CO₂ heat exchanger (5-1), the second FLiNaK—CO₂ heat exchanger (5-2) and the third FLiNaK—CO₂ heat exchanger (5-3) with the molten salt pool (4-2) of the secondary loop system (4); the comprehensive utilization supercritical carbon dioxide Brayton cycle system (5) further comprises a second turbine (5-4), a third turbine (5-5), a fourth turbine (5-6), a second low-temperature regenerator (5-7), a first medium-temperature regenerator (5-8), a second high-temperature regenerator (5-9), a second auxiliary compressor (5-10), a second main compressor (5-11), a third main compressor (5-12), a second cold end heat exchanger (5-13), a third cold end heat exchanger (5-14), a second diverter valve (5-15), a second confluence valve (5-16), a third diverter valve (5-17), a third confluence valve (5-18), and connecting pipes and valves; wherein a second diverter valve first outlet (5.2) is connected to a cold-side inlet of the second high-temperature regenerator (5-9), and a cold-side outlet of the second high-temperature regenerator (5-9) is connected to an inlet of the second FLiNaK—CO₂ heat exchanger (5-2); an outlet of the second FLiNaK—CO₂ heat exchanger (5-2) is connected to an inlet of the first turbine (5-4), and an outlet of the first turbine (5-4) is connected to an inlet of the third FLiNaK—CO₂ heat exchanger (5-3); an outlet of the third FLiNaK—CO₂ heat exchanger (5-3) is connected to an inlet of the second turbine (5-5), and an outlet of the second turbine (5-5) outlet is connected to a hot-side inlet of the second high-temperature regenerator (5-9); a hot-side outlet of the second high-temperature regenerator (5-9) is connected to a second confluence valve first inlet (5.4), and a second diverter valve second outlet (5.3) is connected to an inlet of the first FLiNaK—CO₂ heat exchanger (5-1); an outlet of the first FLiNaK—CO₂ heat exchanger (5-1) is connected to an inlet of the fourth turbine (5-6), and an outlet of the fourth turbine (5-6) is connected to a second confluence valve second inlet (5.5); a second confluence valve outlet (5.6) is connected to a hot-side inlet of the first medium-temperature regenerator (5-8), and a hot-side outlet of the first medium-temperature regenerator (5-8) is connected to a hot-side inlet of the second low-temperature regenerator (5-7); a hot-side outlet of the second low-temperature regenerator (5-7) is connected to a third diverter valve inlet (5.7), and a third diverter valve first outlet (5.8) is connected to an inlet of the second auxiliary compressor (5-10); an outlet of the second auxiliary compressor (5-10) is connected to a third confluence valve first inlet (5.10), and a third diverter valve second outlet (5.9) is connected to an inlet of the second cold end heat exchanger (5-13); an outlet of the second cold end heat exchanger (5-13) is connected to an inlet of the second main compressor (5-11), and an outlet of the second main compressor (5-11) is connected to an inlet of the third cold end heat exchanger (5-14); an outlet of the third cold end heat exchanger (5-14) is connected to an inlet of the third main compressor (5-12), and an outlet of the third main compressor (5-12) is connected to a cold-side inlet of the second low-temperature regenerator (5-7); a cold-side outlet of the second low-temperature regenerator (5-7) is connected to a third confluence valve second inlet (5.11), and a third confluence valve outlet (5.12) is connected to a cold-side inlet of the first medium-temperature regenerator (5-8); a cold-side outlet of the first medium-temperature regenerator (5-8) is connected to a second diverter valve inlet (5.1);
when the comprehensive utilization supercritical carbon dioxide Brayton cycle system (5) is in operation, after being split through the second diversion valve (5-15), a part of CO₂ from a cold side of the first medium-temperature regenerator (5-8) enters a cold side of the second high-temperature regenerator (5-9) to absorb heat, and then enters the second FLiNaK—CO₂ heat exchanger (5-2) to be heated before doing work in the second turbine (5-4); then the CO₂ enters the third FLiNaK—CO₂ heat exchanger (5-3) to be heated, and enters the third turbine (5-5) to do work before releasing heat in a hot side of the second high-temperature regenerator (5-9); the other part of the CO₂ from the cold side of the first medium-temperature regenerator (5-8) enters the first FLiNaK—CO₂ heat exchanger (5-1) to release heat, and enters the fourth turbine (5-6) to do work; the CO₂ from the fourth turbine (5-6) and the hot side of the second high-temperature regenerator (5-9) is combined at the second confluence valve (5-16) and enters a hot side of the first medium-temperature regenerator confluence (5-8) to release heat, and then enters a hot side of the second low-temperature regenerator (5-7) to release heat; after being split through the third diverter valve (5-17), a part of the CO₂ is compressed and pressurized by the second auxiliary compressor (5-10), and the other part of the CO₂ is cooled by the second cold end heat exchanger (5-13) and enters the second main compressor (5-11) to be compressed and pressurized, and then is cooled by the third cold end heat exchanger (5-14) and enters the third main compressor (5-12) to be compressed and pressurized; the two parts of the CO₂ is combined at the third confluence valve (5-18) and enters a cold side of the first medium-temperature regenerator (5-8) to absorb heat, then enters the second diverter valve (5-15) to form a cycle.

2. The multipurpose small modular fluoride-salt-cooled high-temperature reactor energy system, as recited in claim 1, wherein a thermal power of the core active area (1-2) of the reactor body system (1) is 125 MW, a core inlet temperature is 650° C., and a core outlet temperature is 700° C.; FLiBe salt is used as the coolant; mole fractions of LiF and BeF₂ are 67% and 33% respectively; the passive residual heat removal system (2) and the secondary loop system (4) adopts the FLiNaK salt as a cooling medium; mole fractions of LiF, NaF and KF are 46.5%, 11.5% and 42% respectively.

3. The multipurpose small modular fluoride-salt-cooled high-temperature reactor energy system, as recited in claim 1, wherein the core active area (1-2) of the reactor body system (1) adopts helical cruciform fuel elements; TRISO nuclear fuel is dispersed in a matrix with a filling rate of 50%; enrichment of ²³⁵U nuclear fuel is 15% and 17.5%; fuel rods are arranged triangularly in each of the fuel elements, and the fuel elements are also arranged triangularly.

4. The multipurpose small modular fluoride-salt-cooled high-temperature reactor energy system, as recited in claim 1, wherein the main FLiBe—CO₂ heat exchanger (1-4) of the reactor body system (1), as well as the first FLiNaK—CO₂ heat exchanger (5-1), the second FLiNaK—CO₂ heat exchanger (5-2) and the third FLiNaK—CO₂ heat exchanger (5-3) of the comprehensive utilization supercritical carbon dioxide Brayton cycle system (5), are all printed circuit heat exchangers; the FLiBe—FLiNaK main heat exchanger (1-5) of the reactor body system (1), as well as the first FLiBe—FLiNaK residual heat removal heat exchanger (1-6) and the second FLiBe—FLiNaK residual heat removal heat exchanger (1-7) of the passive residual heat removal system (2), are all shell-and-tube heat exchangers.

5. The multipurpose small modular fluoride-salt-cooled high-temperature reactor energy system, as recited in claim 1, wherein a thermal efficiency of the compact supercritical carbon dioxide Brayton cycle system (3) is above 48%, and a thermal efficiency of the comprehensive utilization supercritical carbon dioxide Brayton cycle system (5) is above 54%.

6. The multipurpose small modular fluoride-salt-cooled high-temperature reactor energy system, as recited in claim 1, wherein the reactor vessel (1-1) of the reactor body system (1) has a diameter of less than 3.5 m and a height of less than 3 m.

7. The multipurpose small modular fluoride-salt-cooled high-temperature reactor energy system, as recited in claim 1, wherein the compact supercritical carbon dioxide Brayton cycle system (3) and an energy conversion system formed by the secondary loop system (4) and the comprehensive utilization supercritical carbon dioxide Brayton cycle system (5) are not used synchronically, and are switched according to demands.
